(19) United States
(12) Patent Application Publication
(10) Pub. No.: US 2022/0059964 A1
(43) Pub. Date: Feb. 24, 2022

(54) COVER DETACHMENT PREVENTION STRUCTURE

(71) Applicant: Yazaki Corporation, Tokyo (JP)

(72) Inventors: Ryota ANDO, Shizuoka (JP); Hinata HAYASHI, Shizuoka (JP)

(73) Assignee: Yazaki Corporation, Tokyo (JP)

(21) Appl. No.: 17/407,336

(22) Filed: Aug. 20, 2021

(30) Foreign Application Priority Data
Aug. 21, 2020 (JP) 2020-139821

(51) Int. Cl. H01R 13/447

(52) U.S. Cl. CPC H01R 13/447

(57) ABSTRACT

A cover detachment prevention structure includes an outer housing provided with an opening, and a cover fitted into the outer housing by moving in a predetermined direction with respect to the outer housing and installed in the outer housing to close the opening. The cover is configured such that a force received from another object when the cover abuts on the another object is at least any one of a force directed toward the predetermined direction and a force directed toward a direction orthogonal to the predetermined direction.

### CROSS REFERENCE TO RELATED APPLICATION

The present application is based on, and claims priority from the prior Japanese Patent Application No. 2020-139821 filed on Aug. 21, 2020, the entire contents of which are incorporated herein by reference.

### TECHNICAL FIELD

The present application relates to a cover detachment prevention structure.

### BACKGROUND

JP 2005-56799 A discloses a connector with a built-in substrate including a housing, a substrate, a terminal, and a cover. A first recess and a second recess are provided in the housing of the connector with a built-in substrate. The terminal is installed in the housing, and a first end, which is one end of the terminal, protrudes from the housing in the first recess. A second end, which is the other end of the terminal, protrudes from the housing in the second recess.

### SUMMARY

However, the connector with a built-in substrate disclosed in JP 2005-56799 A may be subjected to an impact when coming into contact with another component and colliding with another object in a process from manufacturing to assembling to a vehicle. At this time, there is a concern that the cover may be detached from the housing.

An object of the present application is to provide a connector with a built-in substrate or a cover detachment prevention structure capable of preventing a cover from being detached from a housing by external force or impact.

A cover detachment prevention structure according to the present embodiment includes a housing provided with an opening, and a cover fitted into the housing by moving in a predetermined direction with respect to the housing and installed in the housing to close the opening. The cover is configured such that a force received from another object when the cover abuts on the another object is at least any one of a force directed toward the predetermined direction and a force directed toward a direction orthogonal to the predetermined direction.

Further, the cover detachment prevention structure may be configured such that in a halfway state where the cover is installed in the outer housing, when a predetermined portion of the housing and a predetermined portion of the cover abut on each other, at least any one of a part of the housing and a part of the cover is elastically deformed, and when the cover is completely installed in the housing, the elastically deformed part is restored, and the cover is fitted into the housing and integrally installed in the housing, and the predetermined portion of the housing and the predetermined portion of the cover are housed inside an external surface of the housing.

Further, the cover detachment prevention structure may be configured such that the housing includes a housing body, a cylindrical portion protruding from the housing body, the opening is formed at a leading end of the cylindrical portion, and the cover is installed inside the cylindrical portion.

Further, the cover detachment prevention structure may be configured such that the cover includes a cover body configured to close the opening, and a cover protrusion slightly protruding from the cover body, and in a state in which the cover is installed in the housing, the cover protrusion protrudes to a side separated from the housing in the predetermined direction from the opening.

The above structure makes it possible to provide a cover detachment prevention structure capable of preventing a cover from being detached from a housing by external force or impact.

### BRIEF DESCRIPTION OF THE DRAWINGS

FIG. 1 is a perspective view of a connector with a built-in substrate using a cover detachment prevention structure according to the present embodiment.

FIG. 2 is a perspective view of the connector with a built-in substrate using the cover detachment prevention structure according to the present embodiment as seen from a direction different from FIG. 1.

FIG. 3 shows a diagram showing a state where a cover is removed from the connector with a built-in substrate shown in FIG. 2.

FIG. 4 is an arrow-IV view in FIG. 1.

FIG. 5 is an arrow-V view in FIG. 1.

FIG. 6 is a sectional view taken along a line VI-VI in FIG. 5.

FIG. 7 is a perspective view of the cover of the connector with a built-in substrate according to the present embodiment as seen from the same direction as FIG. 2.

FIG. 8 is a perspective view of the cover of the connector with a built-in substrate according to the present embodiment as seen from the same direction as FIG. 1.

FIGS. 9A, 9B, and 9C are diagrams showing an assembling procedure of the connector with a built-in substrate using the cover detachment prevention structure according to the present embodiment.

FIGS. 10A, 10B, and 10C are diagrams showing an assembling procedure of the connector with a built-in substrate using the cover detachment prevention structure according to the present embodiment.

FIG. 11 is a diagram showing one mode of use of the connector with a built-in substrate using the cover detachment prevention structure according to the present embodiment.

FIG. 12 is a diagram showing one mode of use of the connector with a built-in substrate using the cover detachment prevention structure according to the present embodiment.

FIGS. 13A to 13G are diagrams for explaining an external surface of the housing of the connector with a built-in substrate using the cover detachment prevention structure according to the present embodiment.

### DETAILED DESCRIPTION

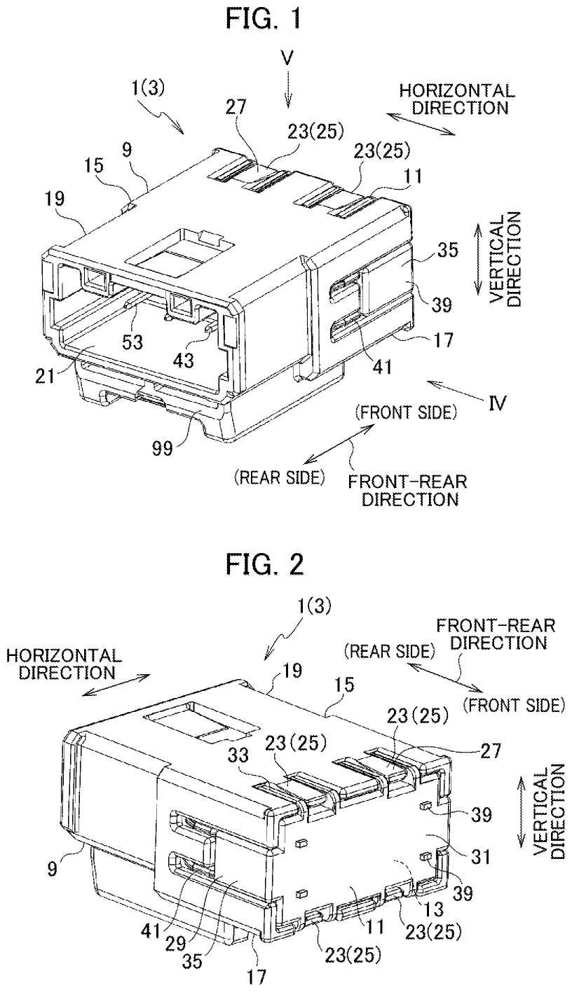

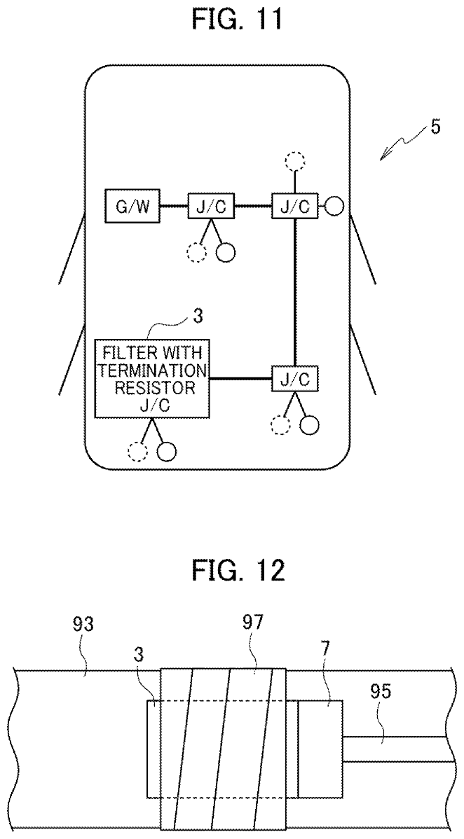

A cover detachment prevention structure 1 according to the present embodiment is used, for example, in a connector with a built-in substrate 3 shown in FIGS. 1 to 6. The connector with a built-in substrate 3 according to the present embodiment is connected to a mating connector 7 and used, for example, in an on-vehicle network (CAN: Controller Area network) 5 as a filter with a termination resistor. The on-vehicle network 5 is shown in FIG. 11, and the mating connector 7 is shown in FIG. 12. The connector with a built-in substrate 3 may be referred to as an electric component connected to the mating connector 7.

Here, for convenience of explanation, a predetermined direction in the connector with a built-in substrate 3 is defined as a vertical direction, a predetermined direction orthogonal to the vertical direction is defined as a horizontal direction, and a direction orthogonal to the vertical direction and the horizontal direction is defined as a front-rear direction.

The cover detachment prevention structure 1 includes a housing (for example, an outer housing) 9 and a cover 11. The outer housing 9 is integrally molded with, for example, an insulating synthetic resin. The outer housing 9 is provided with an opening (first opening) 13.

The cover 11 is also integrally molded with, for example, an insulating synthetic resin. The cover 11 is configured to be engaged with the outer housing 9 only by moving in a predetermined direction with respect to the outer housing 9 (for example, a rear side in the front-rear diction that is a predetermined direction). The cover 11 is fitted into the outer housing 9 by engagement by moving in the predetermined direction, and is installed integrally in the outer housing 9. The cover 11 closes the first opening 13 because it is installed in the outer housing 9.

In a state where the cover 11 is installed in the outer housing 9, the connector with a built-in substrate 3 is brought into abutment with another object (another article) which is not shown. Then, it is configured to exhibit at least one of the following modes: a mode in which the outer housing 9 abuts on another object or a mode in which the cover 11 abuts on another object. In a state where the cover 11 is installed in the outer housing 9, when the connector with a built-in substrate 3 abuts on a plane of another object, only the outer housing 9 abuts on the plane of another object, but the cover 11 does not abut thereon. However, it is assumed that the cover 11 is not provided with a cover protrusion 39 which will be described later.

In a state where the cover 11 is installed in the outer housing 9, when the cover 11 abuts on another object, the cover 11 is configured such that a force received by the cover 11 from another object is at least any one of a force in a first direction and a force in a second direction. The force in the first direction is a force (a force in a direction in which the cover 11 is fitted into the outer housing 9) directed toward the predetermined direction with respect to the outer housing 9 (a rear side in the front-rear diction). That is, the force in the first direction is that the cover 11 is directed toward the outer housing 9 side. The force in the second direction is a force directed toward the direction (horizontal direction and vertical direction) in which the cover 11 is orthogonal to the predetermined direction with respect to the outer housing 9.

A further explanation will be given in this respect. In a surface of the cover 11, a face appearing outside the connector with a built-in substrate 3 is divided into minute faces, and a force vector orthogonal to each of the micro faces and having a directional component pushing the respective micro faces is considered. In addition to expressing a magnitude of the force and a direction of the force, it is assumed that a starting point of the force vector is at the center of the micro face. When the cover 11 abuts on another object, it is configured such that no component of force (component of force directed toward a front side in the front-rear direction) in the direction of pulling the cover 11 from the outer housing 9 is provided regardless of any force vector of the force vectors caused by a force received by the cover 11 from another object. Herein, the force vector having no component of force in the direction in which the cover 11 is pulled out from the outer housing 9 is a force that can be obtained directly by, for example, a human finger. That is, the force vector of the micro face facing a small gap or the like into which a human finger does not enter may have a component of the force in the direction in which the cover 11 is pulled out from the outer housing 9.

In the cover detachment prevention structure 1, at least any one of a part of the outer housing 9 and a part of the cover 11 is elastically deformed in a halfway state where the cover 11 is installed in the outer housing 9. The elastic deformation of a part of the outer housing 9 is generated when a predetermined portion (a predetermined portion of the surface) of the outer housing 9 and a predetermined portion (a predetermined portion of the surface) of the cover 11 come into surface contact with and abut on each other. The elastic deformation of a part of the cover 11 is also generated when a predetermined portion (a predetermined portion of the surface) of the outer housing 9 and a predetermined portion (a predetermined portion of the surface) of the cover 11 come into surface contact with and abut on each other. The elastic deformation will be described later in detail.

More specifically, the elastic deformation of a part of the outer housing 9 in a halfway state where the cover 11 is installed in the outer housing 9 is generated by a pressing force of the cover 11. The elastic deformation of a part of the cover 11 in a halfway state where the cover 11 is installed in the outer housing 9 is generated by a pressing force by the outer housing 9.

In the cover detachment prevention structure 1, when the cover 11 is completely installed in the outer housing 9, the elastically deformed part is restored. That is, when the cover 11 is completely installed in the outer housing 9, the elastically deformed part of the outer housing 9 and the elastically deformed part of the cover 11 are restored. By this restoration, the cover 11 is fitted into the outer housing 9 and integrally installed in the outer housing 9.

In the cover detachment prevention structure 1, the predetermined portion of the outer housing 9 and the predetermined portion of the cover 11 are housed inside an external surface of the outer housing 9. The details of the predetermined portion of the outer housing 9, the predetermined portion of the cover 11, and the external surface will be described later.

More specifically, in a halfway state where the cover 11 is installed in the outer housing 9, the predetermined portion of the outer housing 9 and the predetermined portion of the cover 11 are housed inside the external surface of the outer housing 9. Even in a state where the cover 11 is completely installed in the outer housing 9, the predetermined portion of the outer housing 9 and the predetermined portion of the cover 11 are housed inside the external surface of the outer housing 9.

Further, the outer housing 9 includes a housing body 15 (outer housing body), a cylindrical portion (first cylindrical portion) 17 protruding from the housing body 15, and a second cylindrical portion 19 protruding from the housing body 15 separately from the first cylindrical portion 17.

The first opening 13 is formed at a leading end (a front end in the front-rear direction) of the first cylindrical portion 17, and a second opening 21 is formed at a leading end (a rear end in the front-rear direction) of the second cylindrical portion 19.

The cover 11 moves linearly from a predetermined position, which is separated from the first cylindrical portion 17 by a predetermined distance to the front side, to a direction in which a central axis of the first cylindrical portion 17 is extended toward the first cylindrical portion 17 (a rear side in the front-rear diction). By this movement, the cover 11 is installed inside the first cylindrical portion 17.

The first cylindrical portion 17 is provided with a cover locking portion 23 for locking the cover 11, and the cover 11 is provided with a locked portion 25 which is engaged with the cover locking portion 23 and locked thereto when the cover 11 is installed in the outer housing 9.

When the locked portion 25 is locked to the cover locking portion 23, the cover 11 is prevented from coming off from the outer housing 9 in a state where the cover 11 is installed in the outer housing 9.

In a halfway state where the cover 11 is installed in the outer housing 9, at least any one of a part of the outer housing 9 and a part of the cover 11 is elastically deformed as described above. In the cover detachment prevention structure 1, a part of the outer housing 9 (the predetermined portion) corresponds to the cover locking portion 23, and a part of the cover 11 (the predetermined portion) corresponds to the locked portion 25. In the cover detachment prevention structure 1, the cover locking portion 23 is elastically deformed mainly in a halfway state where the cover 11 is installed in the outer housing 9.

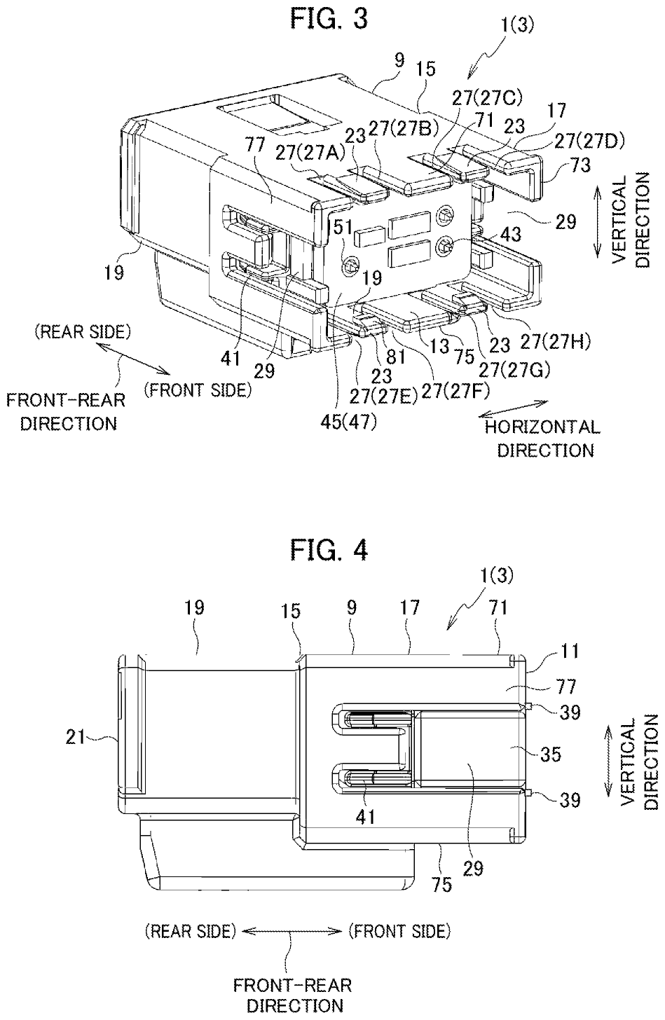

As shown in FIG. 3 and the like, a plurality of recesses 27 are provided in the first cylindrical portion 17 of the outer housing 9. The recess 27 is recessed from the leading end (front end) of the first cylindrical portion 17 toward a base side (rear side) of the first cylindrical portion 17. Further, the recess 27 penetrates through a thick section of the first cylindrical portion 17 from an inner surface to an outer surface in the cylinder of the first cylindrical portion 17. The plurality of recesses 27 are separated from each other in the extending direction of an annular thick section of the first cylindrical portion 17 when seen in the extending direction of the central axis of the first cylindrical portion 17 (front-rear direction). More specifically, the plurality of recesses 27 are provided in a portion of the annular thick section of the first cylindrical portion 17 extending in the horizontal direction.

The cover locking portion 23 is formed in a portion of the first cylindrical portion 17 between two recesses, adjacent to each other, of the plurality of recesses 27. For example, as shown in FIG. 3, the cover locking portion 23 is formed between a recess 27A and a recess 27B, and the cover locking portion 23 is formed between the recess 27C and the recess 27D. Further, the cover locking portion 23 is formed between a recess 27E and a recess 27F, and the cover locking portion 23 is formed between a recess 27G and a recess 27H.

The first cylindrical portion 17 of the outer housing 9 is provided with a recess 29 different from the recesses 27. Similarly to the recess 27, the recess 27 is also recessed from the leading end (front end) of the first cylindrical portion 17 toward the base side (rear side) of the first cylindrical portion 17, and the recess 29 also penetrates through a thick section of the first cylindrical portion 17 from the inner surface to the outer surface in the cylinder of the first cylindrical portion 17. Further, the recess 29 is provided in a portion of the annular thick section of the first cylindrical portion 17 extending in the vertical direction.

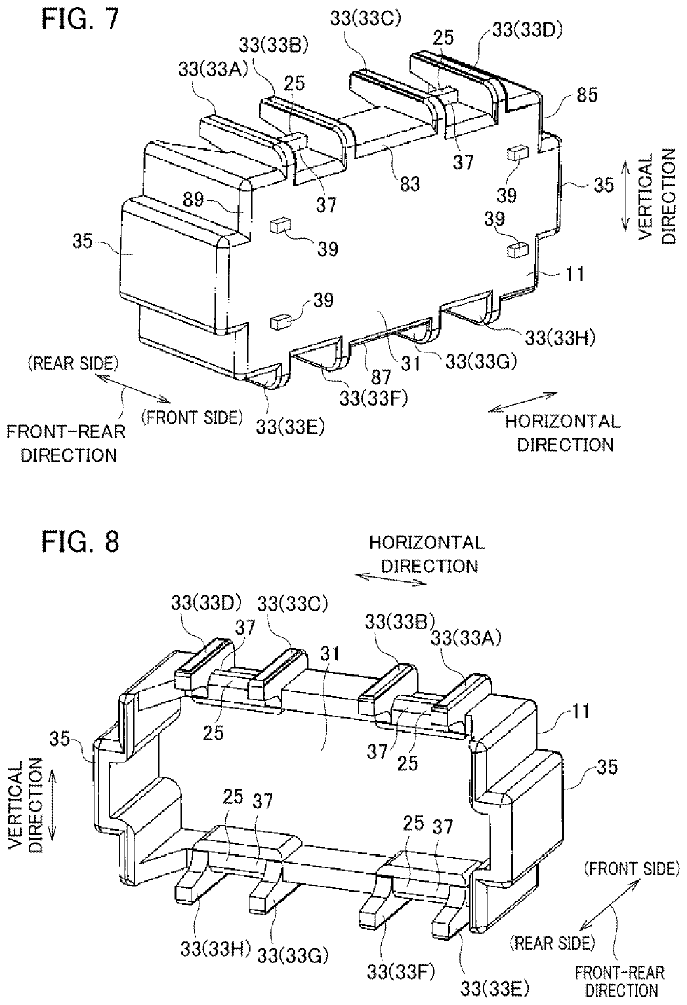

As shown in FIG. 7 and the like, the cover 11 includes a cover body 31 and a plurality of cover protruding portions 33 and 35 and 37 protruding from a periphery of the cover body 31. In a state where the cover 11 is installed in the outer housing 9, the cover body 31 closes the first opening 13, the cover protruding portion 33 closes the recess 27 provided in the first cylindrical portion 17, and the cover protruding portion 35 closes the recess 29 provided in the first cylindrical portion 17.

The locked portion 25 of the cover 11 includes the cover protruding portion 37. The cover protruding portion 37 is formed between the cover protrusions 33 adjacent to each other. For example, as shown in FIG. 7, the cover protruding portion 37 (locked portion 25) is formed between a cover protruding portion 33A and a cover protruding portion 33B, and the cover protruding portion 37 is formed between a cover protruding portion 33C and a cover protruding portion 33D. Further, the cover protruding portion 37 is formed between a cover protruding portion 33E and a cover protruding portion 33F, and the cover protrusion 37 is formed between a cover protruding portion 33G and a cover protruding portion 33H.

In a halfway state where the cover 11 is installed in the outer housing 9, the cover locking portion 23 is elastically deformed mainly by being pushed by the locked portion 25 of the cover body 31. Since the cover locking portion 23 is formed between the two recesses 27 adjacent to each other, it has a cantilever beam-like shape.

When the cover 11 is completely installed in the outer housing 9, the cantilever beam-like cover locking portion 23 is restored, and the locked portion 25 is locked to the cover locking portion 23.

When the cover 11 abuts on another object (for example, a convex of another object), the cover body 31 closing the first opening 13 of the cover 11 receives a force for pushing the cover 11 toward the outer housing 9 side (rear side) from another object.

Further, when the cover 11 abuts on another object, the cover protruding portions 33 and 35, from another object, receive a force (horizontal force and vertical force) in a direction orthogonal to the force pushing the cover 11 toward the outer housing 9 side.

In addition to the cover protruding portions 33, 35, and 37, the cover 11 may be provided with a cover protrusion 39 slightly protruding from the cover body 31. The cover protrusion 39 is formed, for example, in a small rectangular parallelepiped shape. In a state where the cover 11 is installed in the outer housing 9, the cover protrusion 39 may protrude to a side (front side) separated from the outer housing 9 in the front-rear direction which is a predetermined direction from the first opening 13 of the first cylindrical portion 17.

When the cover 11 abuts on another object, the cover protrusion 39 also receives a force pushing the cover 11 toward the outer housing 9 side from another object. Depending on an abutment mode, a force (horizontal force and vertical force) in a direction orthogonal to the force pushing the cover 11 toward the outer housing 9 side is received from another object in place of or in addition to the force pushing the cover 11 toward the outer housing 9 side.

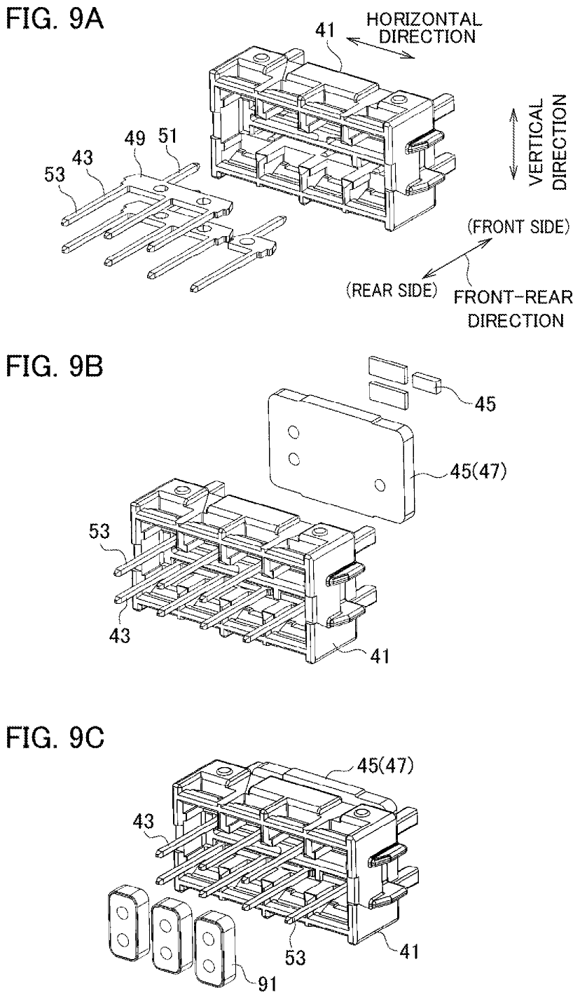

As shown in FIG. 3 and FIG. 6, the connector with a built-in substrate includes an inner housing 41, a terminal 43, and an electric circuit (electronic circuit) 45. The electric circuit 45 is provided on a substrate (circuit substrate) 47. As shown in FIG. 9A, the terminal 43 includes a chain portion 49, a first tab portion 51, and a second tab portion 53.

The terminal 43 is installed in the inner housing 41. The inner housing 41 is installed in the outer housing 9. That is, the terminal 43 is installed in the outer housing 9 via the inner housing 41.

In a state where the terminal 43 is installed in the outer housing 9 together with the inner housing 41, the first tab portion 51 is positioned in the first cylindrical portion 17, and the second tab portion 53 is positioned in the second cylindrical portion 19.

The first tab portion 51 of the terminal 43 is connected to the electric circuit 45. That is, the first tab portion 51 is provided with the substrate 47. The substrate 47 is also housed in the first cylindrical portion 17.

In a state where the terminal 43 and the inner housing 41 are installed in the outer housing 9 and the cover 11 is not installed, as shown in FIG. 3 or the like, the first tab portion 51 and the substrate 47 can be seen from the first opening 13 of the outer housing 9. Further, in a state where the terminal 43 and the inner housing 41 are installed in the outer housing 9, as shown in FIG. 1, the second tab portion 53 can be seen from the second opening 21 of the outer housing 9.

The connector with a built-in substrate 3 will now be described in more detail.

As described above, the outer housing 9 includes the first cylindrical portion 17, the second cylindrical portion 19, and the outer housing body 15. The first cylindrical portion 17 protrudes to the front side from the outer housing body 15, and the second cylindrical portion 19 protrudes to the rear side from the outer housing body 15. The central axis of the first cylindrical portion 17 coincide with the central axis of the second cylindrical portion 19.

The cover 11 is moved to the rear side in the front-rear direction with respect to the outer housing 9 from a state where the cover 11 is positioned on the front side of the outer housing 9 and the cover 11 is postured and positioned appropriately with respect to the outer housing 9. Thus, the cover 11 is engaged with the first cylindrical portion 17 and installed therein, thereby closing the first opening 13 by the cover 11.

When a state where the cover 11 is installed in the outer housing 9 is seen in the front-rear direction, the cover 11 (the cover body 31 and cover protruding portions 33, 35 and 37) is housed inside the outer housing 9 (first cylindrical portion 17).

When a state where the cover 11 having no cover protrusion 39 is installed in the outer housing 9 is seen in the horizontal direction or the vertical direction, the cover 11 is housed inside the outer housing 9 (first cylindrical portion 17). When a state where the cover 11 provided with the cover protrusion 39 is installed in the outer housing 9 is seen in the horizontal direction or the vertical direction, the cover protrusion 39 slightly protrudes forward from the first cylindrical portion 17, as shown in FIG. 4 or the like.

The external surface of the outer housing 9 will now be described. The external surface of the outer housing 9 is a surface shape of the outer housing 9 (including buried portions) formed when all the recesses of the outer housing 9 are buried.

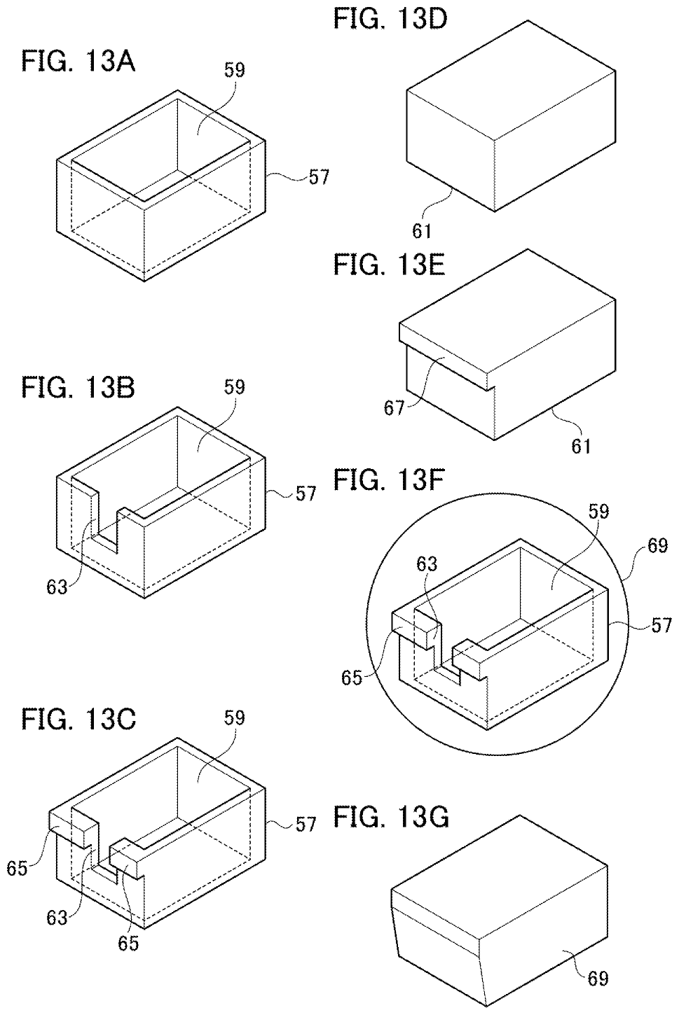

A description will be given with reference to FIG. 13, a square box (rectangular parallelepiped) 57 (simplified form of the outer housing 9) shown in FIG. 13A is taken as an example. A rectangular parallelepiped recess 59 is formed inside the box 57. As the recess 59 is filled, a rectangular parallelepiped 61 shown in FIG. 13D is obtained. All of the surfaces (6 rectangular planes) of the rectangular parallelepiped 61 are the external surfaces of the box 57.

The rectangular parallelepiped box 57 having a cutout 63 on a side wall shown in FIG. 13B is taken as an example. The cutout 63 is also a recess. As the cutout 63 and the recess 59 are filled, the rectangular parallelepiped 61 shown in FIG. 13D is obtained. All the surfaces of the rectangular parallelepiped 61 are the external surfaces of the box 57.

The rectangular parallelepiped box 57 having the cutout 63 and a protrusion 65 on the side wall shown in FIG. 13C is taken as an example. As the cutout 63 and the recess 59 are filled, the rectangular parallelepiped 61 having a protrusion 67 shown in FIG. 13E is obtained. All of the surfaces of the rectangular parallelepiped 61 having the protrusion 67 are the external surfaces of the box 57.

An explanation will be made in a different way. As shown in FIG. 13F, the box 57 shown in FIG. 13C is placed inside a shrinkable container (a film-like container having a hollow inside) 69 such as a heat-shrinkable resin. Thereafter, the container 69 is shrunk until the container 69 comes into contact with the box 57 and entirely covers the box 57 and no recess is formed on a surface of the container 69. As the container 69 is shrunk in this way, a shape of the container 69 (see FIG. 13G) becomes a shape of the external surface of the box 57 shown in FIG. 13C. In this case, it is assumed that there is no thickness of the container 69.

Although the external surface shown in FIG. 13E and the external surface shown in FIG. 13G are slightly different in shape from each other, either the external surface shown in FIG. 13E or the external surface shown in FIG. 13G may be used as a shape of the external surface.

As described above, the cover 11 includes the cover body 31 and the cover protruding portions 33, 35, and 37 protruding from the cover body 31. In a state where the cover 11 is installed in the outer housing 9, the cover body 31 and the cover protruding portions 33, 35, and 37 are housed inside the external surface of the outer housing 9. When the cover protrusion 39 is provided, the cover protrusion 39 slightly protrudes forward from a front end of the external surface of the outer housing 9.

As already understood, the substrate 47 is integrally provided in the inner housing 41 via the terminal 43 (the first tab portion 51).

More specifically, the outer housing 9, the inner housing 41, and the cover 11 form a closed space. The first tab portion 51 of the terminal 43 protrudes in the closed space. This protruding first tab portion 51 is separated from the outer housing 9 and the cover 11. The substrate 47 is joined to the first tab portion 51 and separated from the outer housing 9 and the cover 11.

Thus, even if a force is applied to an outer surface of the connector with a built-in substrate 3, the force does not reach the substrate 47.

In the connector with a built-in substrate 3, the outer housing 9 and the inner housing 41 are joined and integrated with each other, the inner housing 41 and the terminal 43 are joined and integrated with each other, and the terminal 43 and the substrate 47 are joined and integrated with each other.

When the first cylindrical portion 17 of the outer housing 9 is seen in the front-rear direction, a planar side wall 71, a planar side wall 73, a planar side wall 75, and a planar side wall 77 form the first cylindrical portion 17 having a rectangular annular shape. When seen in the front-rear direction, the planar side wall 71 and the planar side wall 75 are parallel to each other and extend in the horizontal direction, and the planar side wall 73 and the planar side wall 77 are parallel to each other and extend in the vertical direction.

The recess (cutout) 27 is formed in the planar side wall 71 and the planar side wall 75, and the recess (cutout) 29 is formed in the planar side wall 73 and the planar side wall 77. The cutout 27 and the cutout 29 are formed in a rectangular shape.

As shown in FIG. 6, the cover locking portion 23 includes a cantilever beam-like cover locking body 79 and a locking portion 81 provided at a leading end of the cover locking body 79. The locking portion 81 slightly protrudes toward a center side of the first cylindrical portion 17 at the leading end of the cover locking body 79.

As shown in FIGS. 7 and 8, the cover 11 is formed in a generally rectangular box shape, in which a rectangular flat plate-shaped bottom plate is positioned on the front side and four rectangular flat plate-shaped side plates protrude from the bottom plate to the rear side. When the cover 11 is seen in the front-rear direction, the cover body 31 is formed in a rectangular shape surrounded by four sides 83, 85, 87, and 89. The side 83 and the side 87 are parallel to each other and extend in the horizontal direction, and the side 85 and the side 89 are parallel to each other and extend in the vertical direction.

The cover protruding portion 33 is formed in a square columnar shape and protrudes from the side 83 and the side 87. The cover protruding portion 35 is formed in a wide square columnar shape and protrudes from the side 85 and the side 89. The cover protruding portion 37 is formed in a square columnar shape and protrudes from the side 83 and the side 87 between the cover protruding portions 33 adjacent to each other. A protrusion amount of the cover protruding portion 37 is smaller than a protrusion amount of the cover protruding portion 33. Further, the cover protruding portion 37 is elongated in the horizontal direction in the whole length between the cover protruding portions 33 adjacent to each other.

The cover protruding portions 33 and 35 extend from a front end face of the cover body 31 toward the rear side, while the cover protruding portion 37 is apart from the front end face of the cover body 31 toward the rear side.

In a halfway state where the cover 11 is installed in the outer housing 9, the cover protruding portion 37 abuts on the locking portion 81 of the cover locking portion 23, and the cover locking body 79 of the cover locking portion 23 is pressed by the cover protruding portion 37. Thus, the cover locking body 79 is bent to the outside of the first cylindrical portion 17.

In a state where the cover 11 is completely installed in the outer housing 9, the locking portion 81 of the cover locking portion 23 passes over the cover protruding portion 37, and the cover locking body 79 is restored as shown in FIG. 6. Thereafter, the cover protruding portion 37 is caught by the locking portion 81 to prevent the cover 11 from coming off from the outer housing 9 (movement to the front side).

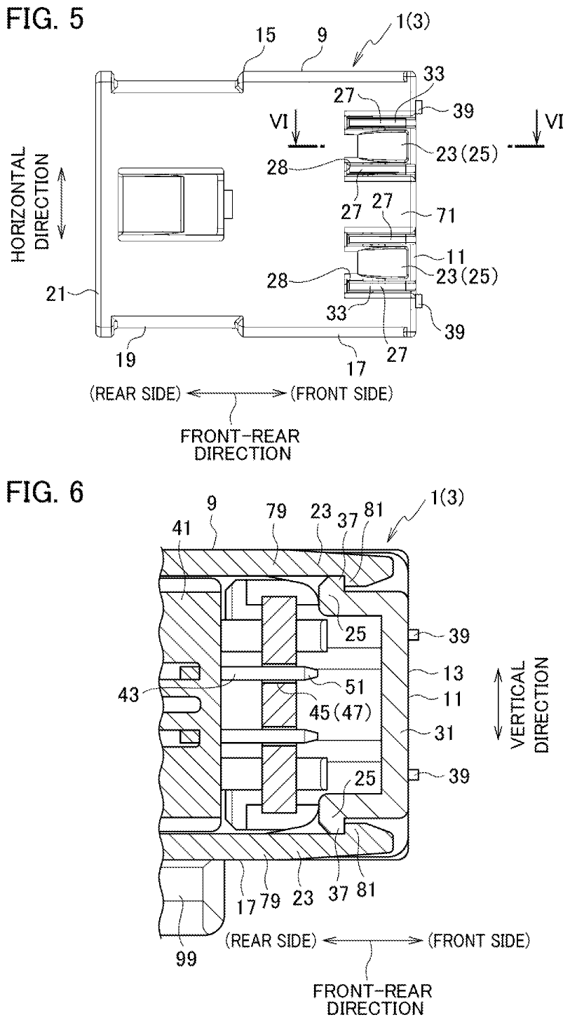

The cover 11 is moved to the rear side with respect to the outer housing 9, and the cover 11 is completely installed in the outer housing 9. At this time, as shown in FIG. 5, for example, the leading end (rear end) of the cover protruding portion 33 abuts on a bottom surface 28 of the recess 27 provided in the first cylindrical portion 17 of the outer housing 9. Thus, the cover 11 can no longer move to the rear side with respect to the outer housing 9.

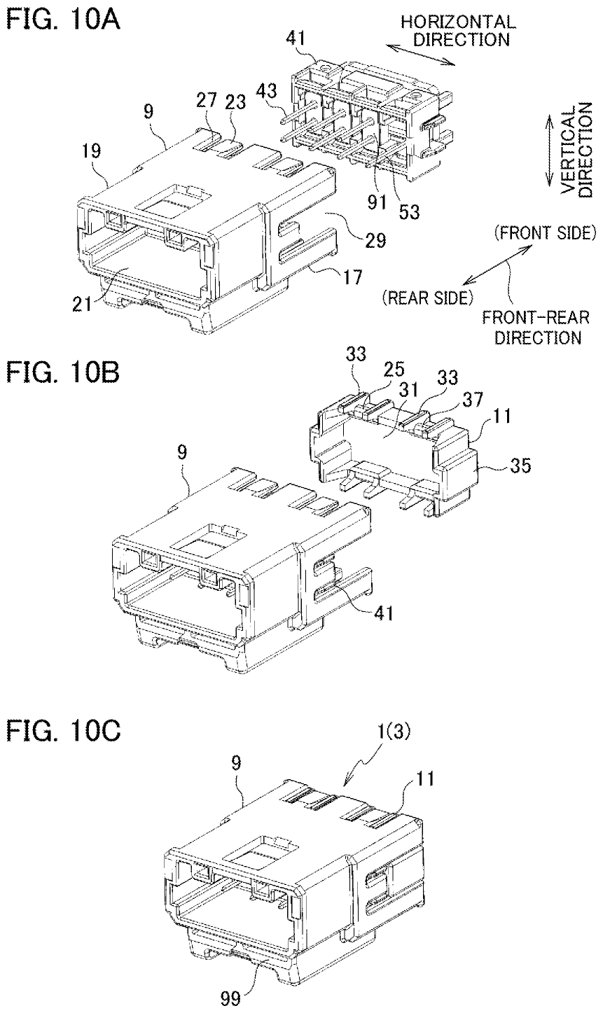

Next, an assembling procedure of the connector with a built-in substrate 3 will be described with reference to FIGS. 9A to 9C and FIGS. 10A to 10C.

First, as shown in FIG. 9A, the terminal 43 is installed in the inner housing 41. The terminal 43 is installed by moving the terminal 43 to the front side with respect to the inner housing 41. Subsequently, as shown in FIG. 9B, the substrate 47 is installed in the terminal 43. The substrate 47 is installed by moving the substrate 47 to the rear side with respect to the terminal 43. Subsequently, as shown in FIG. 9C, a ferrite 91 is installed in the inner housing 41. The ferrite 91 is installed by moving the ferrite 91 to the front side with respect to the inner housing 41 (the terminal 43).

Subsequently, as shown in FIG. 10A, the inner housing 41 is installed in the outer housing 9. The inner housing 41 is installed by moving the inner housing 41 to the rear side with respect to the outer housing 9. Subsequently, as shown in FIG. 10B, the cover 11 is installed in the outer housing 9. Thus, as shown in FIG. 10C, the connector with a built-in substrate 3 is obtained. The cover 11 is installed by moving the cover 11 to the rear side with respect to the outer housing 9.

Next, an installation of the connector with a built-in substrate 3 to a wire harness 93 will be described with reference to FIG. 12.

First, the mating connector 7 is installed in the connector with a built-in substrate 3. Wiring 95 such as an electric wire extends from the mating connector 7. Subsequently, the connector with a built-in substrate 3 is installed in a member to be installed such as a wire harness 93 by using a connector installation body with a built-in substrate such as a tape 97. The connector with a built-in substrate 3 is installed in the wire harness 93, for example, by winding the tape 97 around the wire harness 93 and the connector with a built-in substrate 3 in contact with the wire harness 93.

The outer housing 9 of the connector with a built-in substrate 3 is provided with an outer housing installation portion 99, for example, formed in an annular shape (rectangular cylindrical shape). A string-like installation member (not shown) is passed through the annular outer housing installation portion 99, and this installation member is bound or wound to the wire harness 93. In this way, the connector with a built-in substrate 3 may also be installed in the wire harness 93.

In the cover detachment prevention structure 1, the connector with a built-in substrate 3 is brought into abutment with another object in a state where the cover 11 is installed in the outer housing 9. Then, it is configured to exhibit at least one of the following modes: a mode in which the outer housing 9 abuts on another object or a mode in which the cover 11 abuts on another object.

Further, in the cover detachment prevention structure 1, the cover 11 is brought into abutment with another object. The cover 11 receives, from another object, at least any one of the following forces: a force pushing the cover 11 toward the outer housing 9 side with respect to the outer housing 9 or a force in a direction orthogonal to the force.

With such a configuration, the cover 11 is not easily detached from the outer housing 9 by external force or impact. Since the external force in the direction in which the cover 11 is detached is not applied to the cover 11 even if the connector with a built-in substrate 3 collides with another component, a lock holding force (the cover locking portion 23 and the locked portion 25) necessary for the cover 11 may be minimum. The cover 11 needs only a minimum lock holding force, thereby making it possible to minimize the connector with a built-in substrate 3 by using a small-sized lock.

Next, a comparative example will be described. A connector with a built-in substrate according to a comparative example includes a housing, a substrate, a terminal, and a cover.

The connector with a built-in substrate according to a comparative example is provided with a first recess and a second recess. The terminal is installed in the housing while a first end, which is one end of the terminal, protrudes from the housing in the first recess. A second end, which is the other end of the terminal, protrudes from the housing in the second recess.

The substrate is disposed in the first recess and connected to the first end of the terminal. The cover closes an opening of the first recess of the housing such that the substrate disposed in the first recess and the first end of the terminal are not exposed.

Further, in a state where the cover is installed in the housing, a part of the cover is exposed, and a further part of the exposed portion protrudes from the housing.

As a result, when the connector with a built-in substrate according to the comparative example is subjected to an impact by coming into contact with another component and colliding with another object, there is a concern that the cover may be detached from the housing.

Further, in a process from manufacturing to assembling to a vehicle, when the connector with a built-in substrate according to the comparative example comes into contact with another component, there is a concern that the cover may be caught by another component and detached from the housing.

Since an external force and an impact force received by the cover due to the contact or the like described above are not quantitative or qualitative, it is difficult to estimate a degree of lock holding force required for fixing the cover to the housing.

Further, since the connector with a built-in substrate according to the comparative example is miniaturized, it is difficult to secure a space for setting a strong lock structure to the cover. Furthermore, in order to make the cover resistant to the external force and impact, it is necessary to use a material having a high strength, which is costly.

In the cover detachment prevention structure 1 according to the present embodiment, a predetermined portion of the outer housing 9 and a predetermined portion of the cover 11 abut on each other in a halfway state where the cover 11 is installed in the outer housing 9. Thereafter, at least any one of a part of the outer housing 9 and a part of the cover 11 is elastically deformed.

In the cover detachment prevention structure 1, when the cover 11 is completely installed in the outer housing 9, the elastically deformed part is restored, and the cover 11 is fitted into the outer housing 9 and integrally installed in the outer housing 9. The part to be restored is a part of the outer housing 9 which has been elastically deformed and a part of the cover 11 which has been elastically deformed.

Further, in the cover detachment prevention structure 1, the predetermined portion of the outer housing 9 and the predetermined portion of the cover 11 are housed inside the external surface of the outer housing 9.

With such a configuration, the cover 11 can be easily installed in the outer housing 9 by a so-called one-touch operation. Further, even if the connector with a built-in substrate 3 collides with another object after the cover 11 is installed in the outer housing 9, the predetermined portion of the outer housing 9 (the locking portion 81 of the cover locking portion 23) and the predetermined portion of the cover 11 (the locked portion 25: the cover protruding portion 37) do not abut on another object. As a result, the cover 11 is prevented from coming off from the outer housing 9.

Even when the cover locking body 79 of the cover locking portion 23 collides with another object, the cover locking body 79 is bent only to the center side of the cover 11. Thus, the cover 11 is prevented from coming off from the outer housing 9.

In the connector with a built-in substrate 3, the second tab portion 53 of the terminal 43 is disposed in the outer housing 9 so as to be seen from the second opening 21 of the outer housing 9. This configuration makes it possible to install the mating connector 7 in the connector with a built-in substrate 3 by inserting the mating connector 7 into the second cylindrical portion 19 of the outer housing 9 from the second opening 21.

When the mating connector 7 is connected to the connector with a built-in substrate 3, since the wiring 95 such as an electric wire extends from the mating connector 7, a mode in which the wiring 95 extends from the connector with a built-in substrate 3 is obtained. In this mode, when the connector with a built-in substrate 3 is assembled to a vehicle, the connector with a built-in substrate 3 is swung slightly when holding the wiring 95, so that a large impact force may be applied to the cover 11 of the connector with a built-in substrate 3.

However, since a force in the direction of coming off from the outer housing 9 is not applied to the cover 11, the cover 11 is prevented from coming off from the outer housing 9.

Further, according to the cover detachment prevention structure 1, the cover 11 is disposed inside the first cylindrical portion 17 of the outer housing 9, which makes it possible to close the first opening 13 of the first cylindrical portion 17 by the cover 11 having a simple shape.

Further, in the cover detachment prevention structure 1, the cover locking portion 23 of the outer housing 9 is formed in a portion of the first cylindrical portion 17 between the two recesses 27, adjacent to each other, of the plurality of recesses 27.

This structure makes it possible to elastically and easily deform the cover locking portion 23 (cantilever beam-like locking portion) of the outer housing 9. Thus, a force required for installing the cover 11 in the outer housing 9 can be reduced.

In the cover detachment prevention structure 1, the cover protrusion 39 protrudes forward from the first opening 13 in a state where the cover 11 is installed in the outer housing 9. Thus, only the cover protrusion 39 needs to be pressed when the cover 11 is installed in the outer housing 9, so that the cover body 31 is prevented from being damaged when the cover 11 is installed in the outer housing 9.

In the cover detachment prevention structure 1, when the cover protrusion 39 is not provided in a state where the cover 11 is installed in the outer housing 9, the cover 11 is housed inside the external surface of the outer housing 9. That is, in the cover detachment prevention structure 1, not the structure for covering the cover 11 on the outer housing 9, but the entire structure including a lock structure of the cover (the locked portion 25, etc.) is housed inside the outer housing 9.

With such a configuration, no event occurs in which another component is caught by the cover 11. Thus, a load in a direction in which the cover 11 is detached from the outer housing 9 is not applied to the cover 11.

Further, since the cover 11 is hardly subjected to direct external force or impact, a general-purpose and inexpensive material can be used as the material of the cover 11.

The cover detachment prevention structure 1 described above is an example of a cover detachment prevention structure shown below. The cover detachment prevention structure includes a housing and a cover. The housing is provided with a recess. The cover is fitted into the housing only by moving in a predetermined direction with respect to the housing, thereby being installed integrally in the housing. With this installation, the cover closes an opening of the recess. Further, in a state where the cover is installed in the housing, the cover is housed inside an external surface of the housing.

The cover detachment prevention structure 1 described above is an example of a cover detachment prevention structure shown below. The cover detachment prevention structure includes a housing and a cover. The housing is provided with a recess. The cover is fitted into the housing only by moving in a predetermined direction with respect to the housing, thereby being installed integrally in the housing. With this installation, the cover closes an opening of the recess. When the cover is brought into abutment with another object in a state where the cover is installed in the housing, it is configured to exhibit at least one of the following modes: a mode in which the housing abuts on another object or a mode in which the cover abuts on another object. Further, when the cover is brought into abutment with another object, the cover is configured so as to receive, from another object, at least any one of the following forces: a force directed toward the predetermined direction with respect to the housing or a force directed toward a direction orthogonal to the predetermined direction with respect to the housing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cover detachment prevention structure comprising:
a housing provided with an opening; and
a cover fitted into the housing by moving in a predetermined direction with respect to the housing and installed in the housing to close the opening, wherein
the cover is configured such that a force received from another object when the cover abuts on the another object is at least any one of a force directed toward the predetermined direction and a force directed toward a direction orthogonal to the predetermined direction.

2. The cover detachment prevention structure according to claim 1, wherein
in a halfway state where the cover is installed in the outer housing, when a predetermined portion of the housing and a predetermined portion of the cover abut on each other, at least any one of a part of the housing and a part of the cover is elastically deformed, and when the cover is completely installed in the housing, the elastically deformed part is restored, and the cover is fitted into the housing and integrally installed in the housing, and
the predetermined portion of the housing and the predetermined portion of the cover are housed inside an external surface of the housing.

3. The cover detachment prevention structure according to claim 1, wherein
the housing includes a housing body, a cylindrical portion protruding from the housing body,
the opening is formed at a leading end of the cylindrical portion, and
the cover is installed inside the cylindrical portion.

4. The cover detachment prevention structure according to claim 1, wherein
the cover includes a cover body configured to close the opening, and a cover protrusion slightly protruding from the cover body, and
in a state in which the cover is installed in the housing, the cover protrusion protrudes to a side separated from the housing in the predetermined direction from the opening.
